(19) United States
(12) Patent Application Publication
(10) Pub. No.: US 2011/0283542 A1
(43) Pub. Date: Nov. 24, 2011

(54) Retractable Utility Knife

(76) Inventor: Yuewei Wu, Ninghai (CN)

(21) Appl. No.: 12/784,874

(22) Filed: May 21, 2010

(51) Int. Cl. B26B 5/00; B26B 1/08

(52) U.S. Cl. 30/162

(57) ABSTRACT

A retractable utility knife has a housing, a blade seat forward slidably received in the housing, a blade fixed to the blade seat, a driving unit having an actuator protruding out from the housing and an actuator seat reciprocally slidable along the housing, a blade seat return spring linking the blade seat and the housing, and a blade change means. The blade of the retractable utility knife is also able to be locked when fully extended to avoid painstaking thumb pushing when works for mass workloads.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to a retractable utility knife, and more particularly, to a retractable utility knife a blade of which is also able to be locked at a fully extended position.

2. Description of Related Art

Utility knife is a commonly used hand tool for cutting, e.g., wood, paper, leather, plastic panel, cord, and cardboard. Some retractable utility knives are developed for safer use. As shown in FIG. 4, a conventional retractable utility knife 9 has a blade 90 being able to be pulled into a shell 91 by a spring when a user release an actuator 92 after use. However, since the user has to constantly push the actuator 92 with his thumb in cutting, such utility knife 9 is only suitable for short time occasional uses. For continuing mass workloads, long time pushing become painstaking.

### BRIEF SUMMARY OF THE INVENTION

The main object of the invention is to provide a retractable utility knife a blade of which is also able to be locked when fully extended.

In order to accomplish above object, the invention provides a retractable utility knife having:
a housing having a front recess in an inner surface thereof and a guiding slope;
a blade seat slidably received in the housing and having a seat notch;
a blade fixed to the blade seat and having at least one blade notch;
a driving unit having an actuator protruding out from the housing, an actuator seat reciprocally slidable along the housing, a pole securely formed on the actuator seat, a restore spring provided between the pole and the blade seat, and a stop device having an outer button and an inner part detachably coupling to the outer button;
a blade seat return spring having one end fixed to the blade seat and the other end fixed to the inner surface of the housing; and,
a blade change means having a button and a fixing device.

The button has a pair of legs reciprocally movable with respect to the housing and a sloped foot formed on each the legs. The fixing device is rotatably fixed to the blade seat and has a side protruding pressing finger, a side protruding bias slope, and a bias spring provided between the fixing device and the blade seat. The actuator seat has at least one protrusion formed thereon. The pole is inserted into said blade seat and movable up and down with respect to said blade seat.

These and other objectives, features, and advantages of the present invention will become apparent from the following detailed description, the accompanying drawings, and the appended claims.

### BRIEF DESCRIPTION OF THE SEVERAL VIEWS OF THE DRAWINGS

FIG. 1a is a plane view of the preferred embodiment of the retractable utility knife of the invention.

FIG. 1b is another plane view thereof in a roughly reverse view angle with respect to FIG. 1a.

FIG. 2 is an exploded perspective view thereof.

FIG. 3a is a plane partial view thereof.

FIG. 3b is another plane partial view thereof in a roughly reverse view angle with respect to FIG. 3a.

FIG. 4 is a perspective view of a conventional utility knife.

### DETAILED DESCRIPTION OF THE INVENTION

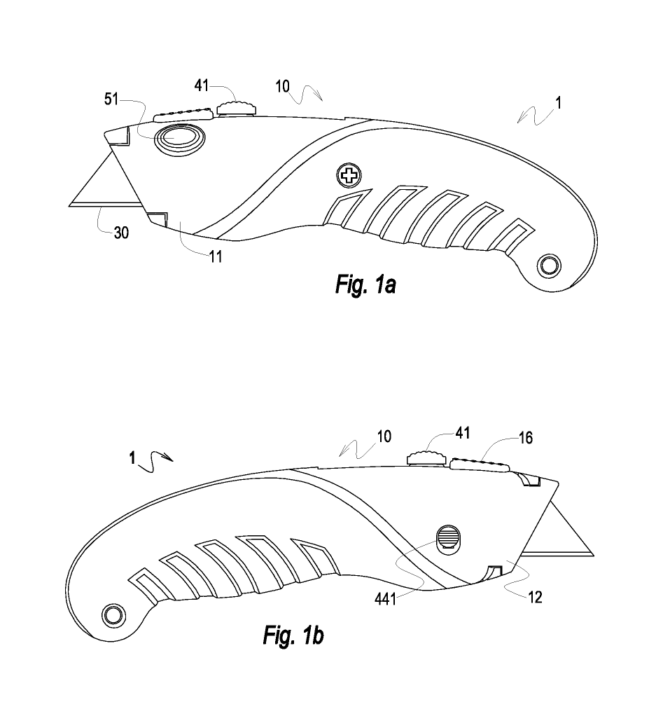

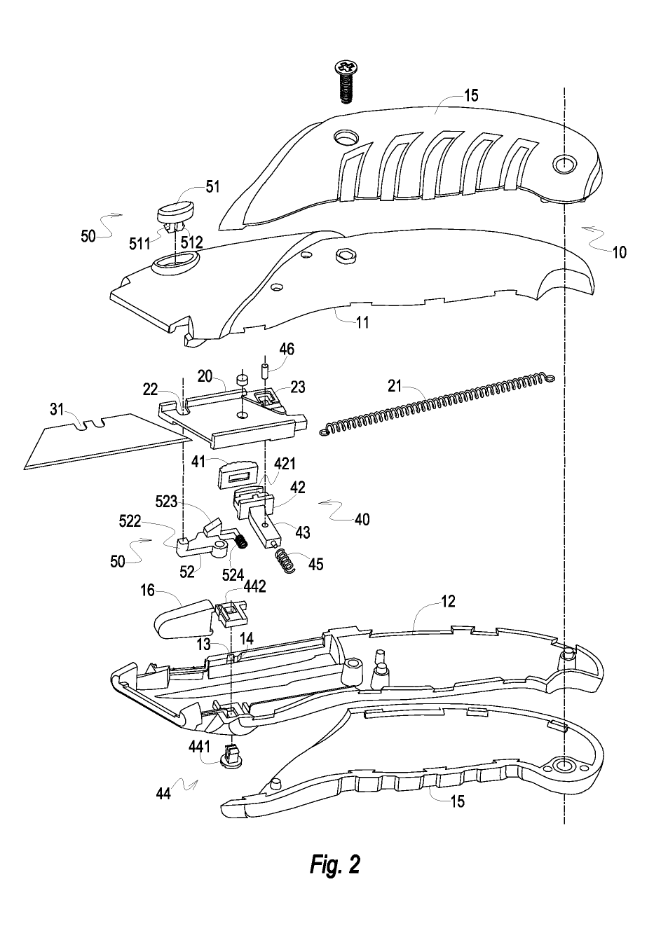

With reference to FIGS. 1a, 1b, and 2, a retractable utility knife 1 of the preferred embodiment of the invention is shown. The utility knife 1 has a housing 10 made up of a first side cover 11 and a second side cover 12 detachably coupling together, a blade seat 20 forward slidably received in the housing 10, a blade 30 having at least one blade notch 31 and fixed to the blade seat 20, a driving unit 40 for controlling the blade seat 20 to move forward, a blade seat return spring 21 one end thereof is fixed to the blade seat 20 and the other end thereof is fixed to an inner surface of the housing 10, and a blade change means 50. The housing 10 acts as both a container for the blade seat 20 and a handle.

The blade change means 50 has a button 51 and fixing device 52. The button 51 has a pair of legs 511 which is contained in a channel defined in the housing 10 and reciprocally movable with respect thereto between an upper most unpressed position and a lower most pressed position. A sloped foot 512 is formed at a free end of each legs 511. The fixing device 52 is rotatable fixed to the blade seat 20 by a pivot 521 and has a side protruding pressing finger 522 and a side protruding bias slope 523. The pressing finger 522 is normally received in a seat notch 22 defined in the blade seat 20 and maintained there by a bias spring 524 provided between the fixing device 52 and the blade seat 20.

The driving unit 40 has an actuator 41 protruding out from the housing 10, an actuator seat 42 reciprocally slidable along the housing 10, a pole 43 securely formed on the actuator seat 42, and a restore spring 45 provided between the pole 43 and the blade seat 20. The pole 43 is inserted into the blade seat 20 and slidable upright with respect to the blade seat 20. At least one protrusion 421 are formed on the actuator seat 42. The driving unit 40 further has a stop device 44 has an outer button 441 for facilitating pushing with a thumb of a user and an inner part 442 detachably coupling to the outer button 441. The stop device 44 is able to reciprocally slidable along the housing 10 between an upper most Unlocked position and a lower most Locked position. A guiding slit 23 may be defined in the blade seat 20 through which a guiding pin 46 formed on the pole 43 passes. The guiding slit 23 and the guiding pin 46 are able to aid the pole 43 move up and down in a roughly upright line with respect to the blade seat 20. A front recess 13 is defined in the inner surface of the housing 10 and a guiding slope 14 is formed on the inner surface of the housing 10 in front of the front recess 13.

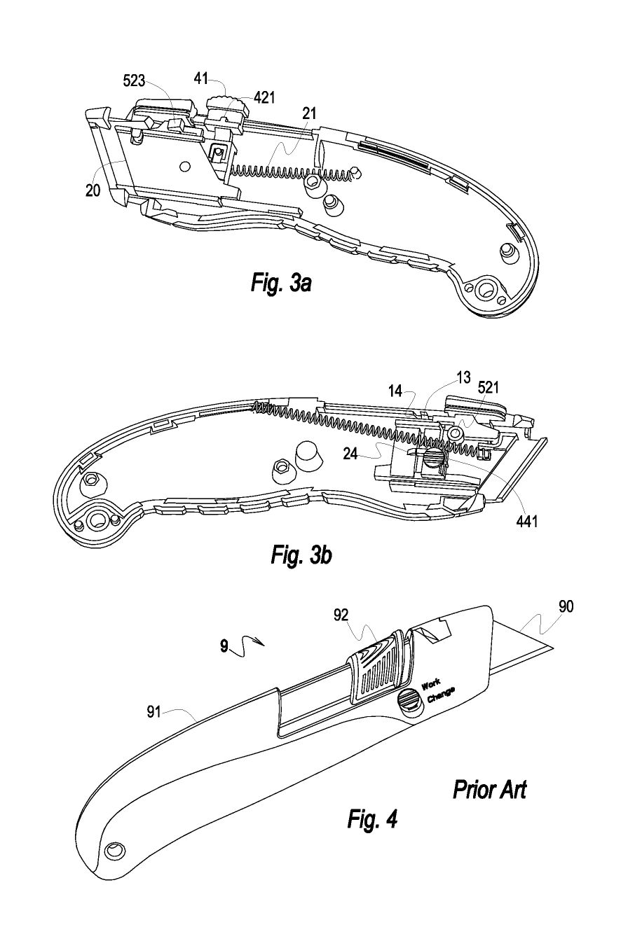

In a spare status of the retractable utility knife 1, the blade seat 20 is pulled by the blade seat return spring 21 to a retracted position. If a user wants to the blade 30 automatically retract back after cutting, he is able to move the outer button 441 upward to the Unlocked position. As shown in FIGS. 3a and 3b, in this status, when the user push the actuator 41 forward to extend the blade 30, a seat protrusion 24 formed on the blade seat 20 will finally meet the inner part 442 of the stop device 44 and be blocked there. The user will not able to move the actuator 41 forward further and the protrusion 421 does not arrive at the guiding slope 14 and the recess 13 yet. When the user release the actuator 41 after use, the blade seat 20, together with the blade 30 installed thereon, will be pulled back into the housing 10 by the blade seat return spring 21.

If the user wants the blade 30 be locked in cutting, he is able to move the outer button 441 downward to the Lock position. In this status, the inner part 442 leaves the way the seat protrusion 24 goes. When the user push the actuator 41 forward to extend the blade 30, the protrusion 421 will first meet the guiding slope 14. If the user keeps pushing, the protrusion 421 will go downward along the guiding slope 14 and the pole 43 will start to compress the restore spring 45. After the protrusion 421 passes over the guiding slope 14, it will enter the recess 13 under a restore force from the just compressed restore spring 45. Thus, the blade seat 20 will be locked there without being able to move forward or backward. Until the user press down the actuator 41 to disengage the protrusion 421 from the recess 13, the blade seat 20 will be able to move back into the housing 10 by the pulling of the blade seat return spring 21.

In the status of Locked, the user is able to change a new blade 30. He may press the button 51 and the sloped foot 512 will meet and push the bias slope 523. The fixing device 52 will be pushed to rotate around the pivot 521 against the bias spring 524. Thus, the pressing finger 522 will leave the seat notch 22 and a blade notch 31. The blade 30 will be able to be pulled out from the utility knife 1 and a new blade 30 will be able to be inserted. After the new blade 30 is inserted, the user is able to release the button 51, and the fixing device 52 will rotate under a bias pressure of the bias spring 524 until the pressing finger 612 enters the seat notch 22 and the blade notch 31. The new blade 30 is thus able to be securely installed.

Back to FIG. 2, a magnet 25 may be fixedly installed on the blade seat 20 on a surface facing the blade 30. The magnet 24 is able to make the blade 30, which is ferrous, stabler with respect to the blade seat 20. A rubber housing cover 15 also may be provided to improve feeling of grasping of the utility knife 1. A rubber anti-slip pad 16 may be provided in front of the actuator 41.

From above description, it could be seen that with the step extending control unit 50, an extending length of the blade 30 of the utility knife 1 becomes step regulatable. According to different thickness of workpiece, a user is able to decide and select a suitable length for cutting, thus decreasing the possibility of break of the blade 30.

From above description, it is seen that the object of the present invention has been fully and effectively accomplished. Embodiment of the invention has been shown and described for the purposes of illustrating the functional and structural principles of the present invention and is subject to change without departure from the invention's principles. Therefore, this invention includes all modifications encompassed within the spirit and scope of the following claims.

1. A retractable utility knife comprising:
a housing having a front recess in an inner surface thereof and a guiding slope;
a blade seat forward slidably received in said housing and having a seat notch;
a blade fixed to said blade seat and having at least one blade notch;
a driving unit having an actuator protruding out from said housing, an actuator seat reciprocally slidable along said housing, a pole securely formed on said actuator seat, a restore spring provided between said pole and said blade seat, and a stop device having an outer button and an inner part detachably coupling to said outer button, said actuator seat having at least one protrusion formed thereon, said pole being inserted into said blade seat and slidable upright with respect to said blade seat;
a blade seat return spring having one end fixed to said blade seat and the other end fixed to said inner surface of said housing; and,
a blade change means having a button and a fixing device, said button having a pair of legs reciprocally movable with respect to said housing and a sloped foot formed on each said legs, said fixing device being rotatably fixed to said blade seat and having a side protruding pressing finger, a side protruding bias slope, and a bias spring provided between said fixing device and said blade seat.

2. The retractable utility knife as claimed in claim 1, wherein said housing is made up of a first side cover and a second side cover detachably coupling together.

3. The retractable utility knife as claimed in claim 1, wherein said blade seat further has a guiding slit defined therein and said pole further has a guiding pin formed thereon.

4. The retractable utility knife as claimed in claim 2, wherein said blade seat further has a guiding slit defined therein and said pole further has a guiding pin formed thereon.

5. The retractable utility knife as claimed in claim 1, wherein said utility knife further has a rubber housing cover.

6. The retractable utility knife as claimed in claim 2, wherein said utility knife further has a rubber housing cover.

7. The retractable utility knife as claimed in claim 3, wherein said utility knife further has a rubber housing cover.

8. The retractable utility knife as claimed in claim 4, wherein said utility knife further has a rubber housing cover.

9. The retractable utility knife as claimed in claim 1, wherein a magnet is fixedly installed on said blade seat on a surface facing said blade.

10. The retractable utility knife as claimed in claim 5, wherein a magnet is fixedly installed on said blade seat on a surface facing said blade.

11. The retractable utility knife as claimed in claim 6, wherein a magnet is fixedly installed on said blade seat on a surface facing said blade.

12. The retractable utility knife as claimed in claim 7, wherein a magnet is fixedly installed on said blade seat on a surface facing said blade.

13. The retractable utility knife as claimed in claim 8, wherein a magnet is fixedly installed on said blade seat on a surface facing said blade.
